(19) United States
(12) Patent Application Publication
(10) Pub. No.: US 2020/0184237 A1
(43) Pub. Date: Jun. 11, 2020

(54) SERVER, IN-VEHICLE DEVICE, PROGRAM, INFORMATION PROVIDING SYSTEM, METHOD OF PROVIDING INFORMATION, AND VEHICLE

(71) Applicant: TOYOTA JIDOSHA KABUSHIKI KAISHA, Toyota-shi (JP)

(72) Inventors: Shin SAKURADA, Toyota-shi (JP); Jun OKAMOTO, Nagoya-shi (JP); Josuke YAMANE, Nissin-shi (JP); Risako YAMAMOTO, Toyota-shi (JP); Kazuki SUGIE, Toyota-shi (JP); Masatoshi KOMIYAMA, Handa-shi (JP)

(73) Assignee: TOYOTA JIDOSHA KABUSHIKI KAISHA, Toyota-shi (JP)

(21) Appl. No.: 16/669,589

(22) Filed: Oct. 31, 2019

(30) Foreign Application Priority Data
Dec. 11, 2018 (JP) 2018-231885

(51) Int. Cl. G06K 9/00; H04N 7/18; H04W 4/48; G06F 16/587; G06F 16/29; G06Q 10/08

(52) U.S. Cl. CPC G06K 9/00838; H04N 7/185; G06K 9/00791; G06Q 10/08; G06F 16/587; G06F 16/29; H04W 4/48

(57) ABSTRACT

A server includes a communication unit that transmits and receives information to and from an in-vehicle device that has a capturing function and a portable terminal, a storage unit that stores empty vehicle information including a location of an empty vehicle based on a location of the in-vehicle device and a captured image of a vehicle for passengers captured by the in-vehicle device, and an information providing unit that transmits, to the portable terminal, the empty vehicle information including a location of an empty vehicle corresponding to a location of the portable terminal acquired from the portable terminal.

### INCORPORATION BY REFERENCE

The disclosure of Japanese Patent Application No. 2018-231885 filed on Dec. 11, 2018 including the specification, drawings and abstract is incorporated herein by reference in its entirety.

### BACKGROUND

### 1. Technical Field

The disclosure relates to a server, an in-vehicle device, a program, an information providing system, a method of providing information, and a vehicle.

### 2. Description of Related Art

A taxi dispatch system has been known in which a taxi distribution status is acquired from a server and a taxi dispatch request is made using a portable terminal. For example, Japanese Unexamined Patent Application Publication No. 2011-248848 (JP 2011-248848 A) discloses a vehicle dispatch system in which location information on taxis is managed at a management center, information on an empty taxi in a current location area of a user, who has transmitted the request for vehicle dispatch using the portable terminal, is provided to the user from the management center, and a vehicle dispatch request is made to a taxi driver.

### SUMMARY

In JP 2011-248848 A, a taxi capable of communicating with the vehicle dispatch system can be dispatched, but a taxi that does not cooperate with the vehicle dispatch system cannot be dispatched. Even when no empty taxi is found in a certain vehicle dispatch system, there may be empty ones among the taxis that do not cooperate with the system. Accordingly, there is room for improving convenience for a user who desired an efficient taxi-taking.

Therefore, the disclosure has made in consideration of the above-mentioned circumstances, and an object of the disclosure is to provide a server, or the like, that improves convenience for users.

A first aspect of the disclosure relates to a server. The server includes a communication unit, a storage unit and an information providing unit. The communication unit is configured to transmit and receive information to and from an in-vehicle device that has a capturing function and a portable terminal. The storage unit is configured to store empty vehicle information including a location of an empty vehicle based on a location of the in-vehicle device and a captured image of a vehicle for passengers captured by the in-vehicle device. The information providing unit is configured to transmit, to the portable terminal, the empty vehicle information including a location of an empty vehicle corresponding to a location of the portable terminal acquired from the portable terminal.

A second aspect of the disclosure relates to an in-vehicle device. The device includes a communication unit, a capturing unit and a second information generating unit. The communication unit is configured to transmit and receive information to and from a server. The capturing unit is configured to capture surroundings of a vehicle. The second information generating unit is configured to generate empty vehicle information including a location of an empty vehicle based on a location of the in-vehicle device and a captured image of a vehicle for passengers, and transmit the empty vehicle information to the server such that the server provides the empty vehicle information to a portable terminal according to a location of the portable terminal.

A third aspect of the disclosure relates to a program that causes an in-vehicle device to execute a process. The process includes capturing surroundings of a vehicle, generating empty vehicle information including a location of an empty vehicle based on a location of the in-vehicle device and a captured image of a vehicle for passengers, and transmitting the empty vehicle information to a server such that the server provides the empty vehicle information to a portable terminal according to a location of the portable terminal.

A fourth aspect of the disclosure relates to a program that causes a portable terminal to execute a process. The process includes transmitting a location of the portable terminal to a server that generates empty vehicle information including a location of an empty vehicle based on a location of an in-vehicle device and a captured image of a vehicle for passengers captured by the in-vehicle device, receiving, from the server, the empty vehicle information having a location of an empty vehicle corresponding to the location of the portable terminal, and outputting the received empty vehicle information.

A fifth aspect of the disclosure relates to an information providing system. The information providing system includes an in-vehicle device and a server, where the in-vehicle device and the server transmit and receive information to and from each other. The in-vehicle device captures surroundings of a vehicle. The in-vehicle device or the server generates empty vehicle information including a location of an empty vehicle based on a location of the in-vehicle device and a captured image of a vehicle for passengers. The server transmits, to a portable terminal, the empty vehicle information having a location of an empty vehicle corresponding to a location of the portable terminal acquired from the portable terminal.

A sixth aspect of the disclosure relates to a method of providing information in a system including an in-vehicle device and a server, which transmit and receive information to and from each other. The method includes capturing surroundings of a vehicle by the in-vehicle device, generating empty vehicle information including a location of an empty vehicle based on a location of the in-vehicle device and a captured image of a vehicle for passengers, by the in-vehicle device or the server, and transmitting, to a portable terminal, the empty vehicle information having a location of an empty vehicle corresponding to a location of the portable terminal acquired from the portable terminal, by the server.

With the server and the like according to the aspects of the disclosure, it is possible to improve convenience for users.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a diagram illustrating a configuration of an information providing system;

FIG. 2 is a diagram illustrating a configuration of a server;

FIG. 3 is a diagram illustrating a configuration of an in-vehicle device;

FIG. 4A is a flowchart illustrating operations of the in-vehicle device;

FIG. 4B is a flowchart illustrating operations of the server;

FIG. 5A is a flowchart illustrating operations of an in-vehicle device of a modification example;

FIG. 5B is a flowchart illustrating operations of a server of the modification example;

FIG. 6 is a sequence diagram illustrating operations of the information providing system; and

FIG. 7 is a diagram showing an output example of empty vehicle information.

### DETAILED DESCRIPTION OF EMBODIMENTS

An embodiment will be described with reference to the drawings.

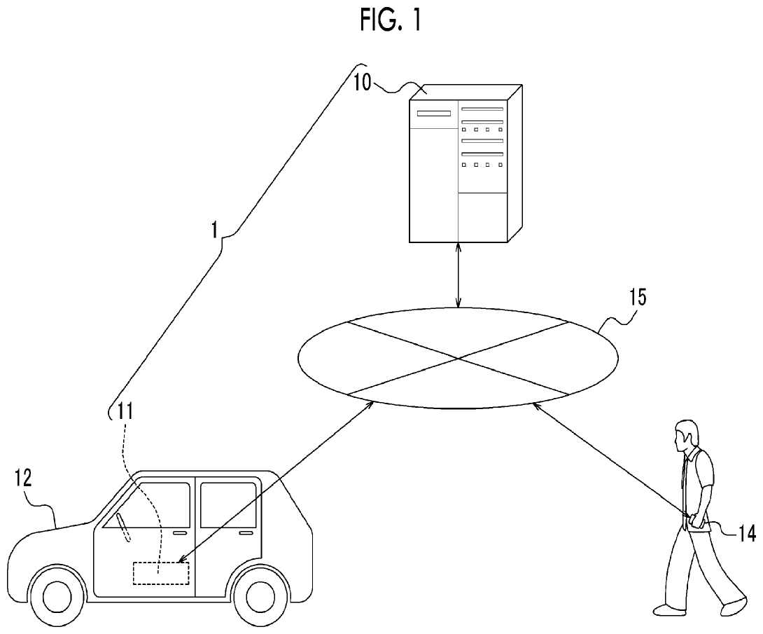

FIG. 1 illustrates a configuration of an information providing system 1 according to the embodiment. The information providing system 1 includes a server 10, and an in-vehicle device 11 mounted in a vehicle 12. The server 10 and the in-vehicle device 11 are connected to each other in a wired or wireless manner through a network 15 to be able to communicate information with each other. The server 10 may be connected to the in-vehicle device 11 (not illustrated for convenience) of each of a plurality of vehicles 12. The vehicle 12 is, for example, an automobile, but is not limited thereto. The vehicle may be any vehicle which a user can get in or on. In addition, a portable terminal 14 being carried by the user is connected to the server 10 through the network 15 in a wired or wireless manner so as to communicate information with each other.

The in-vehicle device 11 captures the surroundings of the vehicle 12 during the moving of the vehicle 12, and transmit, to the server 10, the captured image or empty vehicle information of a vehicle for passengers, such as a taxi, acquired from the captured image. The server 10 generates empty vehicle information from the captured image or acquires empty vehicle information from the in-vehicle device 11, and transmits, to the portable terminal 14, empty vehicle information corresponding to the current location of the portable terminal 14. The user can grasp a location of an empty vehicle in the vicinity of the user by using the portable terminal 14. Therefore, for example, by moving to a point where it is easy to pick up the empty vehicle in advance, the user can take a vehicle efficiently. With the information providing system 1, an empty vehicle is recognized in the captured image in the movement range by each of the vehicles 12, and accordingly, the server 10 can comprehensively grasp presence or absence of the empty vehicle and can provide empty vehicle information according to the current location of the user. Therefore, the user can take a taxi efficiently without being limited to taking the taxi cooperating with a system such as the vehicle dispatch system.

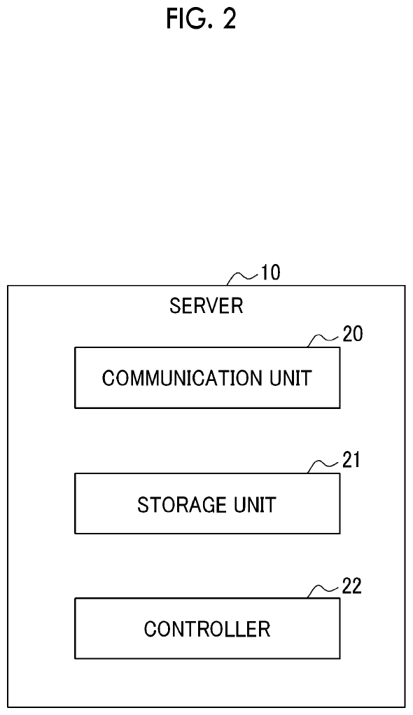

FIG. 2 illustrates a configuration of the server 10. The server 10 includes a communication unit 20, a storage unit 21 and a controller 22. The server 10 is formed of one or a plurality of computers capable of communicating with each other.

The communication unit 20 includes one or more communication modules connected to a network 13. For example, the communication unit 20 may include the communication module compatible with a wired local area network (LAN) standard. In the embodiment, the server 10 is connected to the network 13 through the communication unit 20.

The storage unit 21 includes one or more memories. Each of the memories included in the storage unit 21 functions as, for example, a main storage device, an auxiliary storage device or a cache memory. The storage unit 21 stores any information, control/processing programs, and database, which can be used for the operation of the server 10.

The controller 22 has one or more processors. Each processor is a general-purpose processor or a dedicated processor specialized for a specific processing, but is not limited thereto. The controller 22 controls the operation of the server 10 according to the control/processing program stored in the storage unit 21. In addition, the controller 22 has a clocking function for checking the current time.

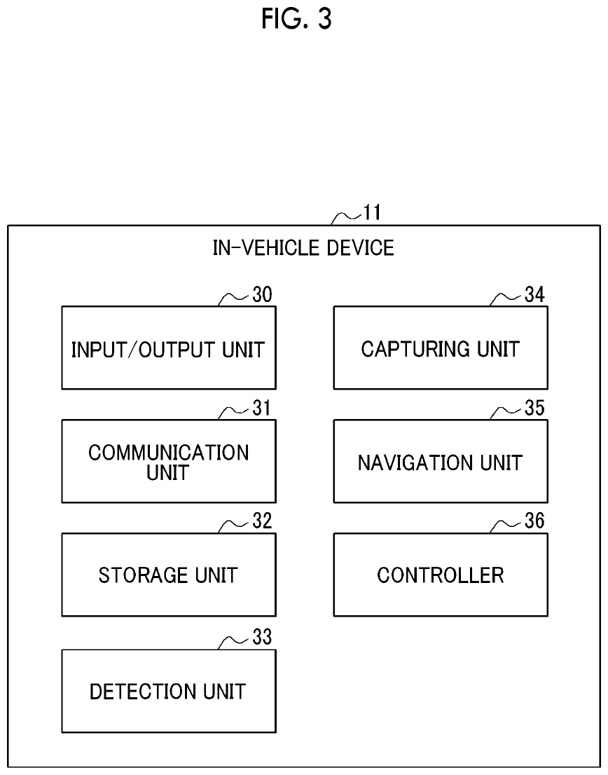

FIG. 3 illustrates a configuration of the in-vehicle device 11. The in-vehicle device 11 includes a communication unit 31, a storage unit 32, a detection unit 33, a capturing unit 34 and a controller 36. The in-vehicle device 11 may be a single device, and may be formed of a plurality of devices.

The communication unit 31 has one or more communication modules. The communication module includes, for example, a module compatible with mobile communication standards such as the 4th generation (4G), the 5th generation (5G), and the like. In addition, the communication unit 31 may have a communication device such as a data communication module (DCM). The in-vehicle device 11 is connected to the network 13 through the communication unit 31, and communicates data with the server 10. The communication module includes a global positioning system (GPS) receiving module. The in-vehicle device 11 receives GPS signals by the communication unit 31.

The storage unit 32 includes one or more memories. Each of the memories included in the storage unit 32 is, for example, a semiconductor memory, a magnetic memory, or an optical memory, but is not limited thereto. Each memory functions, for example, as a main storage device, an auxiliary storage device, or a cache memory. The storage unit 32 stores any information used for the operation of the in-vehicle device 11. For example, the storage unit 32 may store a control/processing program, embedded software, and the like.

The detection unit 33 has, for example, various sensors to detect vehicle speed, a braking force of the brake, an acceleration, a steering angle, a yaw rate, a direction, or the like. The detection unit 33 transmits detection results of the sensors to the controller 36 at a predetermined cycle.

The capturing unit 34 implements a capturing function by the in-vehicle device 11. The capturing unit 34 has one or a plurality of cameras for capturing a scene and an object positioned ahead of the vehicle 12 in the traveling direction of the vehicle 12. The capturing unit 34 may have a camera for capturing images beside the vehicle 12 or behind the vehicle 12. The camera included in the capturing unit 34 may be a monocular camera or a stereo camera. The capturing unit 34 captures the scene and the object outside the host vehicle, generates data on the captured image, and transmits the data to the controller 36.

The controller 36 has one or more processors. Each processor is a general-purpose processor or a dedicated processor specialized for a specific processing, but is not limited thereto. For example, an electronic control unit (ECU) mounted in the vehicle 12 may function as the controller 36. The controller 36 comprehensively controls the operation of the in-vehicle device 11. In addition, the controller 36 has a clocking function for checking the current time.

Returning to FIG. 1, the portable terminal 14 is a portable electronic device, such as a smartphone, a tablet computer, and the like, provided with a communication module connected to the network 15, a storage unit, a controller, and an input/output interface. The portable terminal 14 implements various functions by the controller executing various application programs. In addition, the portable terminal 14 detects its own location, for example, by receiving GPS signals.

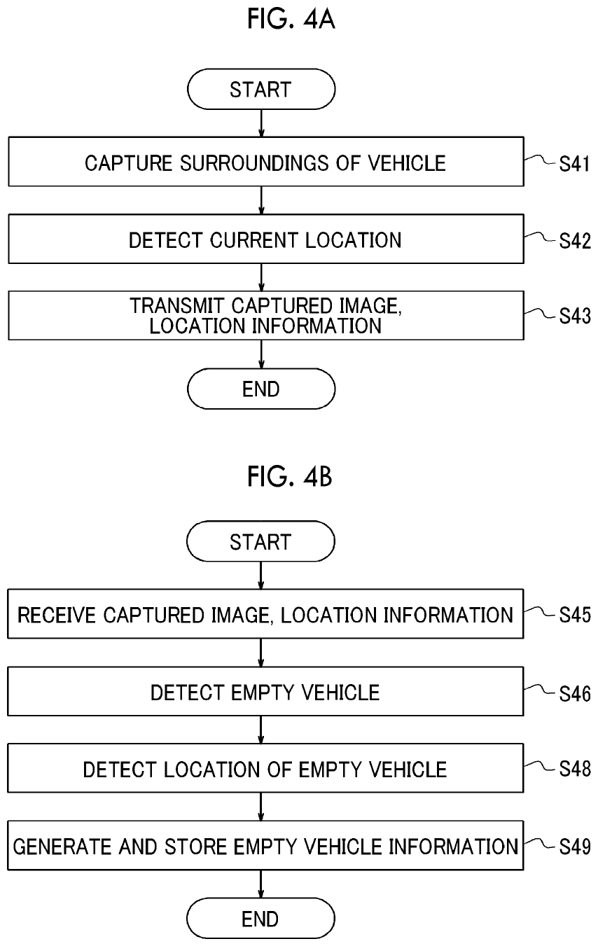

Next, the operation of the information providing system 1 according to the embodiment will be described using FIGS. 4 to 7.

FIG. 4A is a flowchart illustrating operations of the in-vehicle device 11. The procedure illustrated in FIG. 4A is executed at any period (for example, a period of several milliseconds to several seconds) during traveling of the vehicle 12. Alternatively, it may be triggered by any event during traveling of the vehicle 12 (for example, detection of braking/releasing of the brake, constant vehicle speed, constant steering, or the like).

The in-vehicle device 11 captures the surroundings of the vehicle (step S41). For example, the controller 36 instructs the capturing unit 34 to perform capturing, and the capturing unit 34 captures the surroundings of the vehicle 12 in response to the instruction. The capturing region depends on the mounting position of the camera, and is, for example, a region ahead of, behind, or beside the vehicle 12. Next, the in-vehicle device 11 detects the current location (step S42). For example, the current location of the in-vehicle device 11 is detected by the controller 36 acquiring the GPS signal from the communication unit 31. Then, the in-vehicle device 11 transmits the captured image and location information to the server 10 (step S43). For example, the controller 36 acquires data on the captured image from the capturing unit 34, and transmits the data on the captured image and location information on the current location to the server 10 by the communication unit 31.

FIG. 4B is a flowchart illustrating operations of the server 10. The procedure illustrated in FIG. 4B is executed when the data on the captured image is received from one in-vehicle device 11. First, the server 10 receives the data on the captured image and location information from the in-vehicle device 11 (step S45). For example, the controller 22 receives the data on the captured image and the location information by the communication unit 20.

Next, the server 10 detects an empty vehicle from the captured image (step S46). For example, the controller 22 performs processing on the data on the captured image, such as edge recognition, pattern recognition, and the like, and detects the image of a taxi vehicle from the captured image. In addition, the controller 22 detects an empty vehicle by recognizing a display of “empty vehicle” or the like in the image of the recognized taxi vehicle by character recognition and pattern recognition. For image recognition processing or the like on the data on the captured image, any method such as machine learning may be used.

Next, the server 10 detects the location of an empty vehicle (step S48). For example, the controller 22 detects a direction and distance of the vehicle recognized as an empty vehicle from the vehicle 12 that has captured the vehicle. The direction from the vehicle 12 can be derived, for example, by acquiring the direction of the vehicle 12 detected by the detection unit 33 of the vehicle 12 from the in-vehicle device 11 or acquiring the direction of the capturing region with respect to the vehicle 12 from the in-vehicle device 11. In addition, the distance from the vehicle 12 can be detected, for example, by a motion stereo method using continuous images with a monocular camera, a stereo method using parallax of a stereo camera, or the like. Then, the controller 22 derives the location of the empty vehicle, based on the location information indicating the current location of the vehicle 12 and the direction and distance of the empty vehicle from the vehicle 12.

Then, the server 10 generates empty vehicle information including the location of an empty vehicle and stores the generated information (step S49). For example, the controller 22 generates empty vehicle information including the derived location of the empty vehicle and stores the generated information in the storage unit 23. In addition, for example, the controller 22 may derive the movement direction, movement speed and the like of the empty vehicle from temporally continuous captured images acquired from the same in-vehicle device 11 or different in-vehicle devices 11, and include the derived data in the empty vehicle information. Furthermore, the controller 22 may identify the type of a taxi company through the image recognition, and include the identified type in the empty vehicle information.

Here, the controller 22 executing steps S46, S48 and S49 corresponds to the “first information generating unit.”

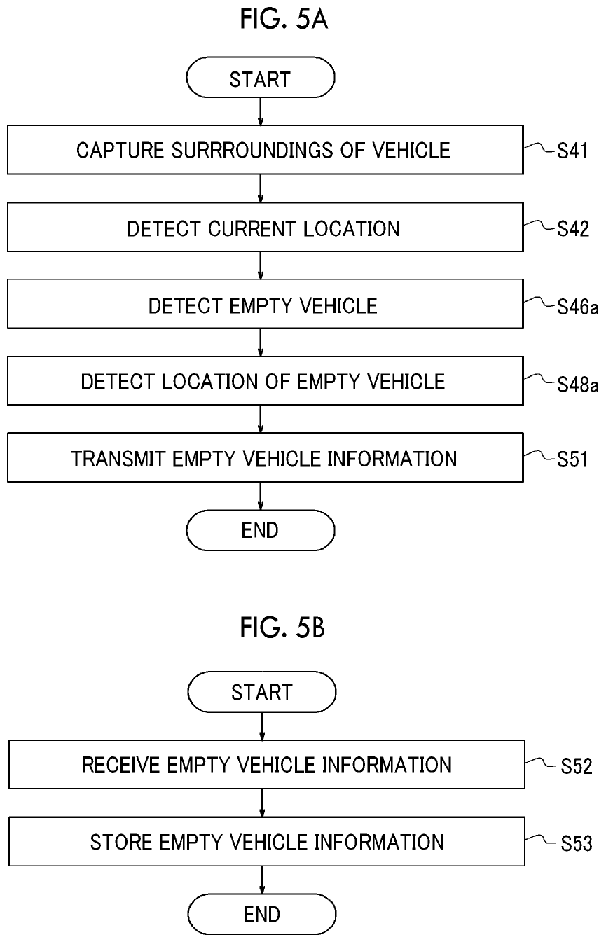

FIGS. 5A and 5B are flowcharts illustrating operations of an in-vehicle device 11 and a server 10 of a modification example, respectively. In FIGS. 5A and 5B, the same steps as those in FIGS. 4A and 4B are denoted by the same reference signs. In the modification example, the in-vehicle device 11 captures surroundings of the vehicle (step S41), detects the current location (step S42), and then detects an empty vehicle (step S46a) and the location of the empty vehicle (step S48a). Then, the in-vehicle device 11 generates empty vehicle information and transmit the empty vehicle information to the server 10 (step S51). Then, the server 10 receives the empty vehicle information for each in-vehicle device 11 (step S52), and stores the empty vehicle information (step S53). Here, the controller 36 executing steps S46a and S48a corresponds to the “second information generating unit”. With the modification example, the processing load of the server 10 can be reduced.

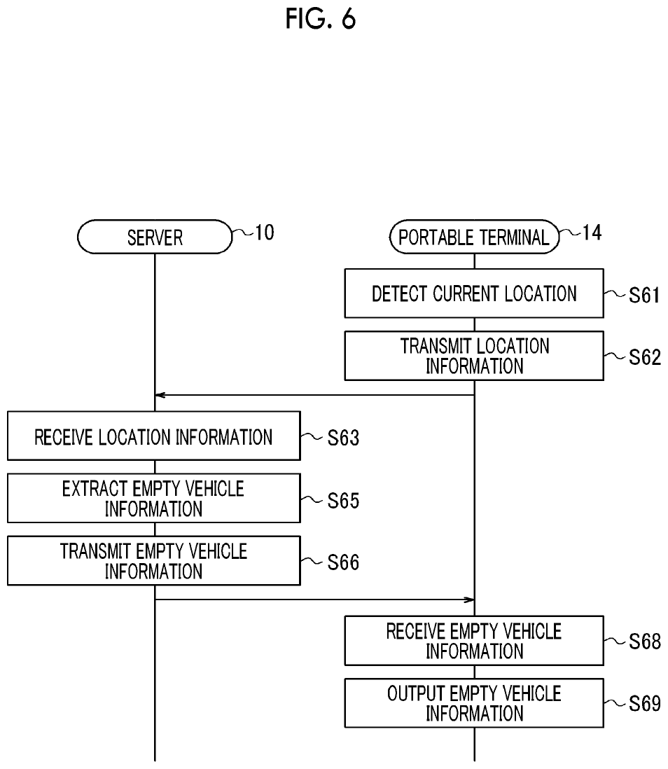

FIG. 6 is a sequence diagram illustrating operation procedures of the server 10 and the portable terminal 14. The procedure of FIG. 6 is executed when the user starts, for example, an application program for detecting an empty vehicle, using the portable terminal 14.

First, the portable terminal 14 detects its own current location (step S61), and transmits location information on the current location to the server 10 (step S62).

Next, the server 10 receives the location information (step S63), extracts empty vehicle information including the location of an empty vehicle corresponding to the location information of the portable terminal 14 (step S65), and transmits the extracted empty vehicle information to the portable terminal 14 (step S66). For example, the controller 22 receives the location information by the communication unit 20. Then, the controller 22 searches for the location of the empty vehicle corresponding to the location information of the portable terminal 14 from the empty vehicle information stored in the storage unit 23. For example, the controller 22 searches for the location of the empty vehicle included in a certain distance range (for example, tens to hundreds of meters) from the current location of the portable terminal 14. Alternatively, when the movement direction, the movement speed, and the like of the empty vehicle are included in the empty vehicle information, it may be added to the searching condition that the empty vehicle approaches the portable terminal 14, or in addition, that the approaching speed of the empty vehicle is faster than a certain reference speed. Then, the controller 22 transmits the searched empty vehicle information from the communication unit 20 to the portable terminal 14. Here, the controller 22 executing steps S63, S65 and S66 corresponds to the “information providing unit”.

Next, the portable terminal 14 receives the empty vehicle information (step S68, and outputs the received empty vehicle information (step S69). The portable terminal 14 displays the empty vehicle information, for example, on a display.

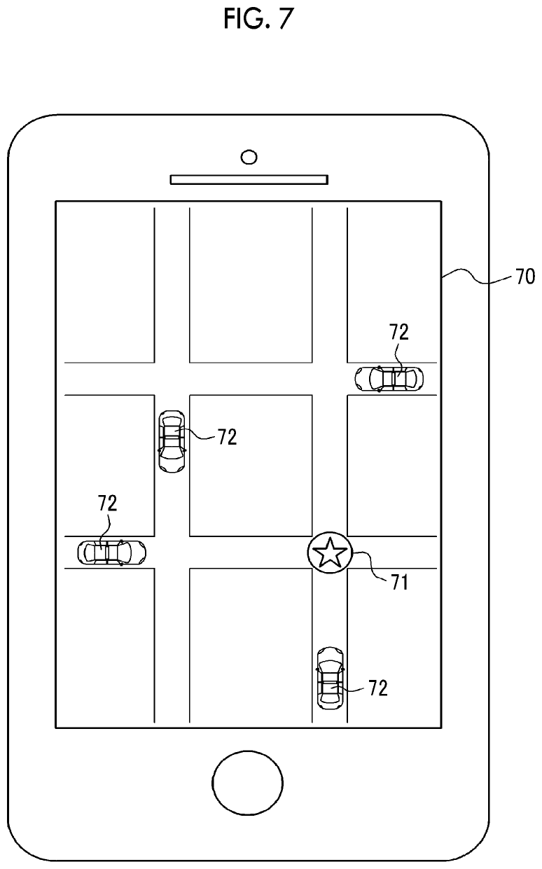

FIG. 7 illustrates an output example of empty vehicle information in the portable terminal 14. For example, the portable terminal 14 displays the current location 71 and the locations 72 of empty vehicles on the map 70. In addition, the portable terminal 14 may update the locations 72 of the empty vehicles on the map 70 as needed according to the movement of the empty vehicle. The portable terminal 14 may output the location of the empty vehicle by voice. The voice message to be output is a message for conveying the location of the empty vehicle to the user by the direction from the current location or a name of a nearby place, for example, “an empty vehicle is found 500m north”, “an empty vehicle is moving west on XX street”, and so on. In addition, when types of taxi companies are included in the empty vehicle information, the types of taxi companies may be distinguished by icon display, or by voice output such as “an empty vehicle of XX taxi is found 500m north”.

As described above, with the information providing system 1 according to the embodiment, the user can comprehensively grasp the presence of the empty vehicle and recognize the location of the empty vehicle, which makes it possible to perform efficient vehicle-taking. Therefore, the convenience of the user is improved.

Furthermore, in the embodiment, the server 10 or the in-vehicle device 11 may make the captured image of the empty vehicle included in the empty vehicle information, and allow the portable terminal 14 to display the captured image of the empty vehicle. For example, when the location 72 of an empty vehicle is touched, the corresponding captured image of the empty vehicle can be displayed. In this way, since the empty vehicle which the user is to take can be recognized in advance by the image, the convenience is further improved.

Further, in the above description, a taxi has been illustrated as an example of the vehicle for passengers. However, the embodiment can be applied even when the vehicle for passengers is, for example, a regular route bus, a tramcar, or the like. For example, the server 10 or the in-vehicle device 11 can identify an internal congestion degree of a regular route bus or a tramcar, which is seen through the car windows thereof, through the image recognition, and determine that the regular route bus or the tramcar is empty if the estimated boarding rate does not satisfy a certain criteria. In this case, the server 10 or the in-vehicle device 11 may further recognize a destination, a route/system number, and the like from display of the regular route bus or the tramcar, and include the recognized data in the empty vehicle information together with operation route information on the map. Also, the portable terminal 14 can display the location of the empty vehicle with the operation route of the regular route bus or the tramcar.

Although the disclosure has been described based on the drawings and examples, it should be noted that those skilled in the art can readily make various modifications and changes based on the disclosure. Therefore, it should be noted that these modifications and changes are included in the scope of the disclosure. For example, functions and the like included in each component or each step can be rearranged so as not to be logically inconsistent, and it is possible to combine or divide a plurality of components into one. Further, the program that causes the controller 36 of the in-vehicle device 11 to perform operations according to the embodiment is also included in the scope of the disclosure.

Furthermore, the network 18 in the embodiment includes, in addition to the above-mentioned example, an ad-hoc network, a local area network (LAN), a metropolitan area network (MAN), a cellular network, a wireless personal area network (WPAN), a public switched telephone network (PSTN), a terrestrial wireless network, an optical network or another network or any combination thereof. Examples of the component of the wireless network include an access point (for example, a Wi-Fi access point), a femtocell, or the like. Furthermore, the wireless communication device can be connected to a wireless network using Wi-Fi (registered trademark), cellular communication technology or other wireless technology and technology standard, in addition to Bluetooth (registered trademark).

As described above, various aspects of the disclosure can be implemented with many different modifications, all of which fall within the scope of the embodiment.

What is claimed is:

1. A server comprising:
a communication unit configured to transmit and receive information to and from an in-vehicle device that has a capturing function and a portable terminal;
a storage unit configured to store empty vehicle information including a location of an empty vehicle based on a location of the in-vehicle device and a captured image of a vehicle for passengers captured by the in-vehicle device; and
an information providing unit configured to transmit, to the portable terminal, the empty vehicle information including a location of an empty vehicle corresponding to a location of the portable terminal acquired from the portable terminal.

2. The server according to claim 1, further comprising a first information generating unit configured to generate the empty vehicle information based on the location of the in-vehicle device and the captured image received from the in-vehicle device.

3. The server according to claim 1, wherein the information providing unit acquires, from the in-vehicle device, the empty vehicle information based on the location of the in-vehicle device and the captured image, the empty vehicle information being generated by the in-vehicle device.

4. The server according to claim 1, wherein the empty vehicle information includes the captured image of the vehicle for passengers.

5. The server according to claim 1, wherein the empty vehicle information includes an operation route of the vehicle for passengers.

6. An in-vehicle device comprising:
a communication unit configured to transmit and receive information to and from a server;
a capturing unit configured to capture surroundings of a vehicle; and
a second information generating unit configured to
generate empty vehicle information including a location of an empty vehicle based on a location of the in-vehicle device and a captured image of a vehicle for passengers, and
transmit the empty vehicle information to the server such that the server provides the empty vehicle information to a portable terminal according to a location of the portable terminal.

7. A program that causes an in-vehicle device to execute a process comprising:
capturing surroundings of a vehicle;
generating empty vehicle information including a location of an empty vehicle based on a location of the in-vehicle device and a captured image of a vehicle for passengers; and
transmitting the empty vehicle information to a server such that the server provides the empty vehicle information to a portable terminal according to a location of the portable terminal.

8. A program that causes a portable terminal to execute a process comprising:
transmitting a location of the portable terminal to a server that generates empty vehicle information including a location of an empty vehicle based on a location of an in-vehicle device and a captured image of a vehicle for passengers captured by the in-vehicle device;
receiving, from the server, the empty vehicle information having a location of an empty vehicle corresponding to the location of the portable terminal; and
outputting the received empty vehicle information.

9. An information providing system comprising:
an in-vehicle device; and
a server, the in-vehicle device and the server transmitting and receiving information to and from each other, wherein;
the in-vehicle device captures surroundings of a vehicle;
the in-vehicle device or the server generates empty vehicle information including a location of an empty vehicle based on a location of the in-vehicle device and a captured image of a vehicle for passengers; and
the server transmits, to a portable terminal, the empty vehicle information having a location of an empty vehicle corresponding to a location of the portable terminal acquired from the portable terminal.

10. A method of providing information in a system including an in-vehicle device and a server, which transmit and receive information to and from each other, the method comprising:
capturing surroundings of a vehicle, by the in-vehicle device;
generating empty vehicle information including a location of an empty vehicle based on a location of the in-vehicle device and a captured image of a vehicle for passengers, by the in-vehicle device and the server; and
transmitting, to a portable terminal, the empty vehicle information having a location of an empty vehicle corresponding to a location of the portable terminal acquired from the portable terminal, by the server.

11. A vehicle comprising the in-vehicle device according to claim 6.
